(19) United States
(12) Patent Application Publication
(10) Pub. No.: US 2013/0009884 A1
(43) Pub. Date: Jan. 10, 2013

(54) ELECTRONIC DEVICE WITH STYLUS

(75) Inventors: HAN-CHE WANG, Tu-Cheng (TW); CHIH-SAN CHIANG, Tu-Cheng (TW); HUA-DONG CHENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/217,302

(22) Filed: Aug. 25, 2011

(30) Foreign Application Priority Data
Jul. 8, 2011 (CN) 201110190702.7

(51) Int. Cl. G06F 3/041

(52) U.S. Cl. 345/173

(57) ABSTRACT

An electronic device includes a stylus, a touch screen, and a processing unit. The touch screen includes a plurality of touch spots arranged in a matrix. The stylus includes a flexible and conductive nib including a plurality of flexible sub-nibs, and a body for receiving the nib and sub-nibs. The sub-nibs touching the touch screen causes changes in the charges of the touch spots actually touched. The processing unit determines the number of the touch spots which have been touched according to changes in the charges of the touch spots, and controls the weight or lightness of the corresponding stroke displayed on the touch screen according to the determined number of the touched touch spots.

### BACKGROUND

1. Technical Field

The present disclosure relates to an electronic device with a stylus.

2. Description of the Related Art

A user can input information such as a letter to an electronic device having a touch-sensitive screen through using a conductive object such as a stylus to touch the screen. A standard stylus includes a single nib similar to a conventional pen, thus while writing on the screen using the stylus, the width or weight of the strokes displayed on the screen are the same not with standing the writing pressure applied.

Therefore, there is room for improvement within the art.

### BRIEF DESCRIPTION OF THE DRAWINGS

The components in the drawings are not necessarily drawn to scale, the emphasis instead being placed upon clearly illustrating the principles of an electronic device with a stylus. Moreover, in the drawings, like reference numerals designate corresponding parts throughout the several views.

FIG. 1 is a schematic view of an electronic device with a stylus in accordance with an exemplary embodiment.

FIG. 2 is a block diagram of the electronic device of FIG. 1 in accordance with an exemplary embodiment.

### DETAILED DESCRIPTION

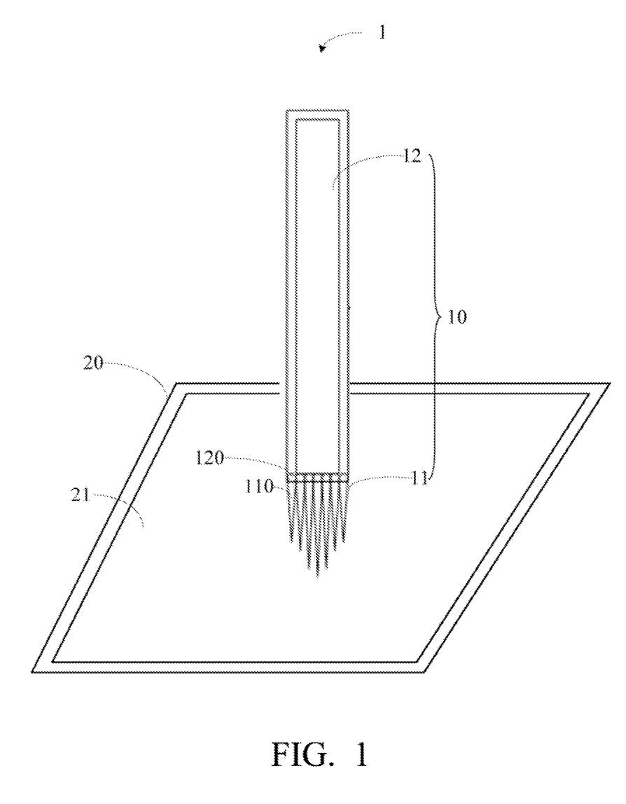

Referring to FIG. 1, an electronic device 1 includes a stylus 10 and a main body 20. The main body 20 includes a touch screen 21. The stylus 10 includes a nib 11 and a body 12.

The body 12 is to be held by users. In the embodiment, the shell of the body 12 is made of conductive material, and electrically connected to the nib 11. The touch screen 21 is a resistive touch screen. When the nib 11 touches the touch screen 21, the electrical charge(s) (charges) of the touched spot changes. The body 12 includes a fixing portion 120 for securing the nib 11 to the body 12.

The nib 11 includes a number of flexible and conductive sub-nibs 110 arranged in a predetermined sequence. In the embodiment, the lengths of all of the sub-nibs 110 are different, the length of the sub-nib 110 in the middle is the longest, and the lengths of the remaining sub-nibs 110 gradually decrease moving from the middle of the nib 11 to the sides. The sub-nibs 110 are made of conductive resilient material.

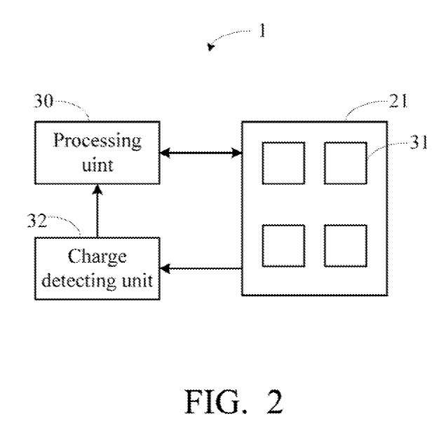

Referring to FIG. 2, the main body 20 further includes a processing unit 30. The touch screen 21 includes a plurality of spots which are sensitive to being touched (touch spots 31) arranged in a matrix. When the stylus 10 touches the touch screen 21, the number of the sub-nibs 110 found to be touching the touch screen 21 increases as the downward pressure applied the stylus 10 increases. Correspondingly, the number of the touch spots 31 actually touched by the sub-nibs 110 increases, causing the charges of the touch spots 31 to change. In the embodiment, the main body 20 further includes a charge detecting unit 32 for detecting any change in the charges of the touch spots 31. In the embodiment, the number of the touch spots 31 actually touched is in direct proportion to the weight or lightness of the stroke displayed on the touch screen 21. The processing unit 30 determines the number of the touched touch spots 31 according to any change noted in the charges of the touch spots 31.

The processing unit 30 further determines the duration of a change of the charge of each touched touch spot 31, and controls the color of the corresponding stroke displayed on the touch screen 21, according to the determined duration. In the embodiment, the processing unit 30 darkens the color of the stroke which is displayed as representing the touched touch spot 31 as the duration of the changes noted in the charges of the touched touch spot 31 extends in time.

The present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a main body comprising a touch screen and a processing unit, the touch screen comprising a plurality of touch spots arranged in a matrix; and
a stylus comprising:
a flexible and conductive nib comprising a plurality of flexible sub-nibs, the plurality of flexible sub-nibs touching on the touch screen causing the charge of touched touch spots changes;
a body to receive the nib;
the processing unit to determine the number of the touched touch spots according to the change of the charges of the touch spots, and control the lightness of a stroke displayed on the touch screen according to the determined number of the touched touch spots.

2. The electronic device as described in claim 1, wherein the processing unit is further configured to determine a duration of the change of the charges of each of the touched touch spots, and control the color of a stroke displayed on each of the touched touch spots according to the determined duration.

3. The electronic device as recited in claim 2, wherein the processing unit is configured to gradually darken the color of the stroke displayed on the touched touch spots as the duration of the change of the charge of the touched touch spot gradually increases.

4. The electronic device as recited in claim 1, wherein the nib is electrically connected to the body.

5. The electronic device as recited in claim 1, wherein the main body further comprises a charge detecting unit to detect the change of the charges of the plurality of touch spots.

6. The electronic device as recited in claim 1, wherein the number of the touched touch spots is in direct proportion to the lightness of a stroke displayed on the touch screen.

7. The electronic device as recited in claim 1, wherein the body is made of conductive material.

8. The electronic device as recited in claim 7, wherein the body comprises a fixing portion for securing the nib thereto.

9. The electronic device as recited in claim 1, wherein the plurality of sub-nibs are made of conductive rubber material.

10. The electronic device as recited in claim 1, wherein the lengths of all of the plurality of sub-nibs are different, and the length of the sub-nib in the middle of the nib is the longest, and the lengths of the remaining sub-nibs gradually decrease from the middle of the nib.
